(19) United States
(12) Patent Application Publication
(10) Pub. No.: US 2013/0254729 A1
(43) Pub. Date: Sep. 26, 2013

(54) DEVICE AND METHOD FOR CHECKING SIGNAL TRANSMISSION LINES OF PCB LAYOUT FILES

(71) Applicants: YA-LING HUANG, Shenzhen City (CN); CHIA-NAN PAI, Tu-Cheng (TW); SHOU-KUO HSU, Tu-Cheng (TW)

(72) Inventors: YA-LING HUANG, Shenzhen City (CN); CHIA-NAN PAI, Tu-Cheng (TW); SHOU-KUO HSU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/585,855

(22) Filed: Aug. 15, 2012

(30) Foreign Application Priority Data
Mar. 20, 2012 (CN) 201210074249.8

(51) Int. Cl. G06F 17/50

(52) U.S. Cl. 716/112

(57) ABSTRACT

A device and a method reads a circuit printed circuit (PCB) layout file, extracts arrangement information of all the interference source components and signal transmission lines of the PCB layout file, and selects a interference source component from the PCB layout file, then determines if there is any signal transmission line is laid under the selected interference source component.

### BACKGROUND

1. Technical Field

Embodiments of the present disclosure relate to printed circuit board (PCB) layout checking devices and methods, and particularly, to a device and a method for checking signal transmission lines of a PCB layout file.

2. Description of Related Art

PCB production processes may include designing a PCB layout, and manufacturing a printed wiring board (i.e., a bare board) according to the PCB layout.

Now a PCB may include more than one layer and set up with thousands of signal transmission lines in different layers. During the design process of the PCB, a signal transmission line may be laid under an interference source component (such as magnetic component, crystal oscillator or clock chip), and if a signal transmission line laid under an interference source component in a manufactured PCB, the signal transmission line and the interference source component may interfere with each other. Therefore, it is necessary to incorporate design simulations and checks during the design and layout process of the PCB. With the large number of signal transmission lines distributed on the PCB, manual check operations are not only time-consuming, but also error-prone.

### BRIEF DESCRIPTION OF THE DRAWINGS

FIG. 1 is a block diagram of one embodiment of a device for checking signal transmission lines of a PCB layout file.

FIG. 2 is a block diagram of one embodiment of function modules of a checking unit in the device of FIG. 1.

FIG. 3 is a flowchart of one embodiment of a method for checking signal transmission lines of a PCB layout file.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may include programmable units, such as programmable gate arrays or processors. The modules described herein may be implemented as either software and/or hardware modules and may be stored in any type of computer-readable medium or other computer storage device.

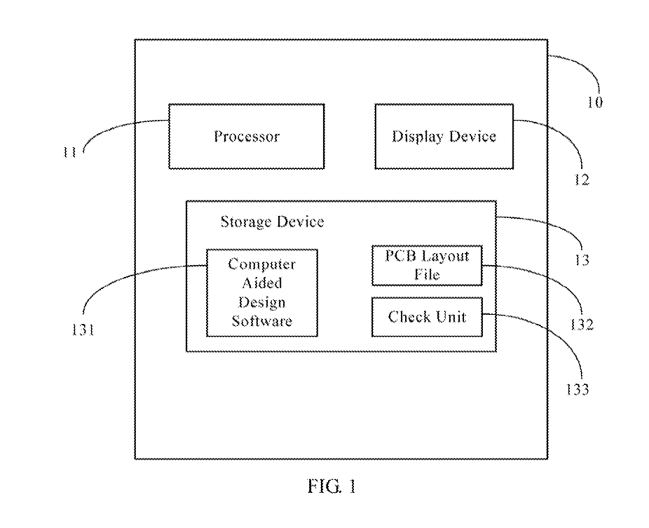

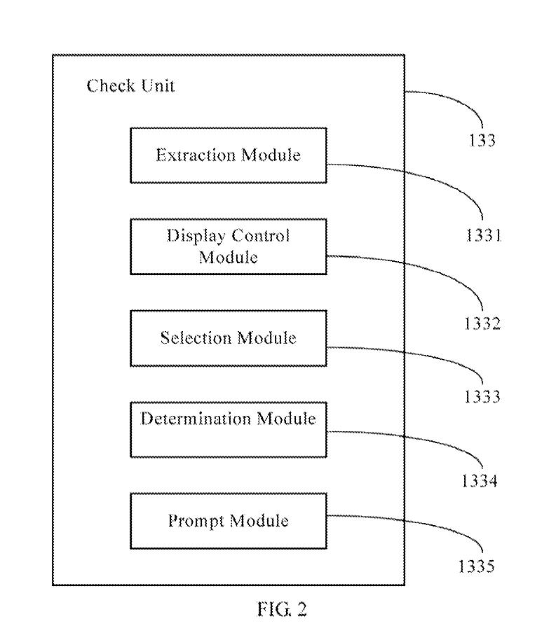

FIG. 1 is a block diagram of one embodiment of a device 10 for checking a PCB layout file. The device 10 includes a processor 11, a display device 12, and a storage device 13. The storage device 13 stores a computer aid design (CAD) software 131, a printed circuit board PCB layout file 132 and a checking unit 133. The CAD software 131 reads the PCB layout file 132 and provides a graphic user interface (GUI) for displaying and editing the PCB layout file 132. The checking unit 133 includes a number of function modules (as shown in FIG. 2). The function modules may include computerized code in the form of one or more programs that are stored in the storage device 13. The computerized code includes instructions that are executed by the processor 11, to check if there is any signal transmission line laid under any interference source component in the PCB layout file 132. The PCB layout file 132 can include one or more files detailing arrangement information of interference source components and signal transmission lines of one or more printed circuit boards. The storage device 13 may be a smart media card, a secure digital card, or a compact flash card. The device 10 may be a personal computer, or a server, for example.

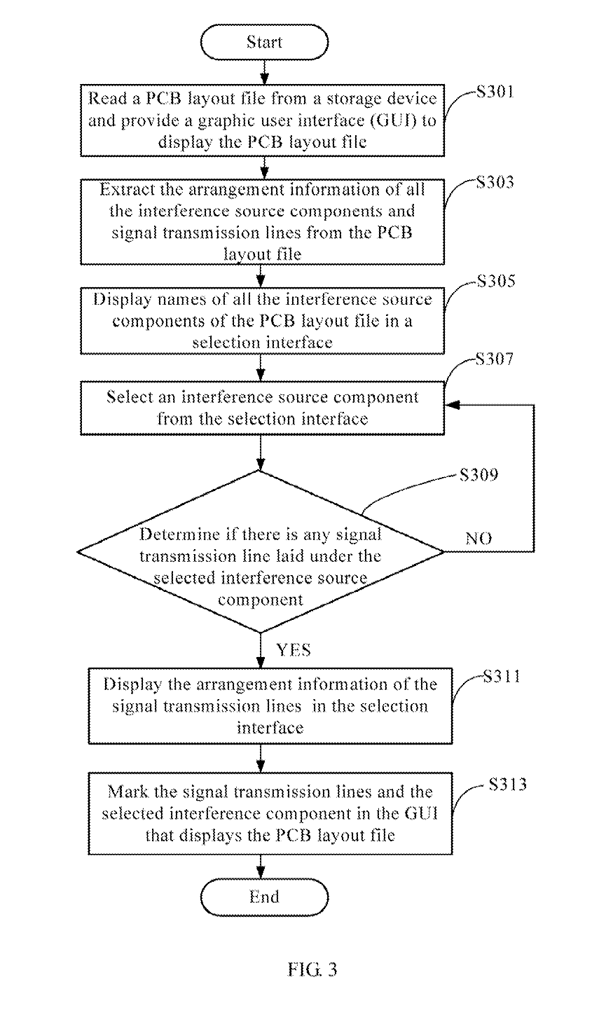

FIG. 2 is a block diagram of the function modules of the checking unit 133 in the device 10 of FIG. 1. In one embodiment, the checking unit 133 includes an extraction module 1331, a display control module 1332, a selection module 1333, a determination module 1334, a prompt module 1335. A detailed description of the modules 1331-1335 is illustrated in FIG. 3.

FIG. 3 is a flowchart of one embodiment of a method for checking signal transmission lines of the PCB layout file 132 implemented by the device 10. It is noted that additional steps may be added, others removed, and the ordering of the steps may be changed.

In step S301, the CAD software 131 reads the PCB layout file 132 from the storage device 13 and provides a GUI to allow a user to edit the PCB layout file 132.

In step S303, the extraction module 1331 extracts arrangement information of all the interference source components and signal transmission lines from the PCB layout file 132. As mentioned above, the PCB layout file 132 includes arrangement information of all the interference source components and signal transmission lines of a PCB, such as the number, names and position data of the interference source components and the signal transmission lines arranged on the PCB.

In step S305, the display control module 1332 displays a selection interface which lists names of all the interference source components extracted from the PCB layout file in the selection interface and allows a user to make a selection of the interference source components from the selection interface.

In step S307, the selection module 1333 receives an interference source component selection from the user. In the embodiment, the user can select one interference source component at one time. In other embodiments, the user may select more than one interference source components at one time.

In step S309, the determination module 1334 checks if there is any signal transmission lines laid under the interference source component selected in step S307. If the position data of any signal transmission line overlaps with the position data of the selected interference source component, the signal transmission line is determined to be laid under the selected interference source component, and then the procedure goes to step S311 Otherwise, the procedure goes to step S307.

In step S311, the display control module 1332 displays the arrangement information of the determined signal transmission lines laid under the interference source component selected in step S307 in the selection interface. The arrangement information includes names and position data of the signal information lines.

In step S313, the prompt module 1335 marks the signal transmission lines and the interference source component selected in step S307 in the GUI that displays the PCB layout file 132. For example, the prompt module 1335 may highlight the interference source component and the signal transmission line in the PCB layout file 132.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method implemented by a processor of a device for checking signal transmission lines in a printed circuit board (PCB) layout file, the method comprising:
reading a PCB layout file from a storage device and providing a graphic user interface (GUI) to display the PCB layout file via the device, the PCB layout file comprising arrangement information of interference source components and signal transmission lines of a PCB;
extracting the arrangement information of all the interference source components and signal transmission lines from the PCB layout file via the device, wherein the arrangement information comprises numbers, names and position data of the interference source components and signal transmission lines;
displaying names of all the interference source components of the PCB layout file in a selection interface;
selecting an interference source component from the selection interface;
determining if there is any signal transmission line laid under the selected interference source component; and
displaying the arrangement information of the signal transmission lines in the selection interface if there is any signal transmission line laid under the selected interference source component.

2. The method as claimed in claim 1, further comprising:
marking the signal transmission lines determined to be laid under the selected interference source component and the selected interference component in the GUI that displays the PCB layout file.

3. The method as claimed in claim 1, wherein if the position data of any signal transmission line overlap with the position data of the selected interference source component, the signal transmission line is determined to be laid under the selected interference source component.

4. A device for checking a PCB layout file, comprising:
a storage device;
a display device;
a processor; and
one or more programs stored in the storage device and executable by the processor, the one or more programs comprising instructions to:
read a PCB layout file from a storage device and provide a graphic user interface (GUI) to display the PCB layout file, the PCB layout file comprising arrangement information of interference source components and signal transmission lines of a PCB;
extract the arrangement information of all the interference source components and signal transmission lines from the PCB layout file, wherein the arrangement information comprising numbers, names and position data of the interference source components and signal transmission lines;
display names of all the interference source components of the PCB layout file in a selection interface;
select an interference source component from the selection interface;
determine if there is any signal transmission line laid under the selected interference source component; and
display the arrangement information of the signal transmission lines in the selection interface if there is any signal transmission line laid under the selected interference source component.

5. The PCB layout checking device as claimed in claim 5, wherein the one or more programs further comprise instructions to:
mark the signal transmission lines determined to be laid under the selected interference source component and the selected interference component in the GUI that displays the PCB layout file.

6. The PCB layout checking device as claimed in claim 5, wherein if the position data of any signal transmission line overlap with the position data of the selected interference source component, the signal transmission line is determined to be laid under the selected interference source component.

7. A non-transitory computer readable medium storing a set of instructions, the set of instructions being executable by a processor of a device to implement a method for checking signal transmission lines in a printed circuit board PCB layout file, the method comprising:
reading a PCB layout file from a storage device and providing a graphic user interface (GUI) to display the PCB layout file, the PCB layout file comprising arrangement information of interference source components and signal transmission lines of a PCB;
extracting the arrangement information of all the interference source components and signal transmission lines from the PCB layout file, wherein the arrangement information comprising numbers, names and position data of the interference source components and signal transmission lines;
displaying names of all the interference source components of the PCB layout file in a selection interface;
selecting an interference source component from the selection interface;
determining if there is any signal transmission line laid under the selected interference source component; and
displaying the arrangement information of the signal transmission lines in the selection interface if there is any signal transmission line laid under the selected interference source component.

8. The medium as claimed in claim 9, wherein the method further comprises:
mark the signal transmission lines determined to be laid under the selected interference source component and the selected interference component in the GUI that displays the PCB layout file.

9. The medium as claimed in claim 9, wherein if the position data of any signal transmission line overlap with the position data of the selected interference source component, the signal transmission line is determined to be laid under the selected interference source component.
